(19) United States
(12) Patent Application Publication
(10) Pub. No.: US 2012/0090509 A1
(43) Pub. Date: Apr. 19, 2012

(54) METHOD FOR MAKING CONCRETE FROM DRILLING WASTE BYPRODUCTS

(76) Inventor: George M. Albert, Pittston, PA (US)

(21) Appl. No.: 13/313,254

(22) Filed: Dec. 7, 2011

Related U.S. Application Data
(60) Provisional application No. 61/506,320, filed on Jul. 11, 2011.

(51) Int. Cl. C04B 2/00

(52) U.S. Cl. 106/792

(57) ABSTRACT

The present application discloses systems and methods for utilizing drilling byproducts from gas and oil wells to make commercially-marketable concrete. According to one inventive concept, the byproducts (which includes drill cuttings and flow-back) are treated with a dewatering agent to form a waste slurry, and the waste slurry is then added to a concrete-mixing process as the final component, after all of the other components of the concrete-mixing process have already been blended together. In some embodiments, the dewatering agent is calcium oxide (CaO). According to another inventive concept, the drilling byproducts that are collected from a first drilling site may be used to form the concrete that is to form a concrete drilling pad that is located at a second drilling site.

### CROSS REFERENCE TO RELATED APPLICATION(S)

This application claims the benefit of U.S. Provisional Application No. 61/506,320, filed Jul. 11, 2011, the entire contents of which are incorporated herein by reference as if fully set forth.

### FIELD OF THE INVENTIVE CONCEPTS

The herein disclosed inventive concepts relate to the field of systems and methods for utilizing drilling byproducts to make commercially-marketable concrete.

### BACKGROUND OF THE INVENTIVE CONCEPTS

Ground drilling for natural resources, for example oil and natural gas reserves, necessarily generates drilling byproducts (hereinafter “byproducts”) which must be disposed of. These byproducts comprise drilling cuttings and tailings, brine water, and flow-back that may include a number of environmental contaminants. One known method of disposing of byproducts is deep-well injection, where the byproducts are injected into wells located deep underground. Some drawbacks to deep-well injection are that: the additional underground volume and pressure generated by the injected byproducts may contribute to seismic activity; the byproducts have the potential to leak into sources of drinking water; and the high costs of the process. Another known method for disposing of byproducts is to first drain off the brine water and flow-back and transport these fluids to a sewage treatment plant, and then to mix the sludge (wet, solid waste) with a solidifier (e.g., wood chips and/or lime) and transport this solidified waste to a landfill. There are several drawbacks to this method of disposal. First, there is a high cost associated with transporting both the liquid and solid wastes to their respective disposal locations. Second, the liquid byproducts need to be sent through a sewage treatment plant, which adds strain on existing sewage-treatment facilities and increases the risk of delivering environmental contaminants into the drinking-water supply. Third, some governmental agencies place substantial regulations on the treatment and disposal of the sludge byproducts, which results in high disposal costs for drilling companies.

Accordingly, there is a need for improved systems and methods for disposal of drilling byproducts that address these and other drawbacks of prior art disposal systems and methods.

### SUMMARY OF THE INVENTIVE CONCEPTS

In a first respect, the present application teaches the inventive concept of a method for producing concrete from drilling byproducts, the method comprising: mixing the drilling byproducts with a sufficient amount of a dewatering agent to form a waste slurry having a desired saturation percentage; blending together all of the components of concrete except for the waste slurry to form an intermediate mixture; and mixing the waste slurry into the intermediate mixture to form a concrete mixture.

In a second respect, the present application teaches the inventive concept of a method for producing concrete, the method comprising: blending together cement, a coarse aggregate, and water to form an intermediate mixture; and mixing drilling byproducts into the intermediate mixture to form a concrete mixture.

In a third respect, the present application teaches the inventive concept of a method of using drilling byproducts to form a concrete drilling pad, the method comprising: making a concrete mixture from drilling byproducts that are collected from a first drilling site; and using the concrete mixture to form a concrete drilling pad at a second drilling site.

### BRIEF DESCRIPTION OF THE DRAWINGS

The herein disclosed inventive concepts will hereinafter be described in conjunction with the appended drawing figures.

FIG. 1 is a schematic view of an exemplary method of making concrete using the byproducts from a drilling operation; and

FIG. 2 is a schematic view of an exemplary method of using drilling byproducts from a first drilling site to form the concrete that is to be poured to form a drilling pad at a second drilling site.

### DETAILED DESCRIPTION OF THE PREFERRED EMBODIMENTS

The ensuing detailed description provides preferred exemplary embodiments only, and is not intended to limit the scope, applicability, or configuration of the inventive concepts. Rather, the ensuing detailed description of the preferred exemplary embodiments will provide those skilled in the art with an enabling description for implementing the preferred exemplary embodiments of the inventive concepts. It should be understood that various changes may be made in the function and arrangement of elements without departing from the spirit and scope of the inventive concepts, as set forth in the appended claims.

To aid in describing the inventive concepts, directional terms may be used in the specification and claims to describe portions of the present inventive concepts (e.g., upper, lower, left, right, etc.). These directional definitions are merely intended to assist in describing and claiming the inventive concepts and are not intended to limit the inventive concepts in any way. In addition, reference numerals that are introduced in the specification in association with a drawing figure may be repeated in one or more subsequent figures without additional description in the specification in order to provide context for other features.

As used in the specification and claims, “saturation percentage” refers to the percentage of total void volume in a solid mixture that is occupied by water molecules. In other words, the sum total of all of the three-dimensional volumetric spaces present between the solid particles (e.g., soil particles) in a mixture represents a total void volume, and the percentage of that total void volume which is occupied by water molecules represents the measured saturation percentage of that mixture. For example, a 90% saturation percentage means that 90% of the total void volume in a solid mixture is occupied by water molecules. By way of further example, a 0% saturation percentage means that 0% of the total void volume in a solid mixture is occupied by water molecules, i.e., no water is present in this mixture.

Broadly, the present application discloses systems and methods for utilizing drilling byproducts to make commercially-marketable concrete. Byproducts from the drilling process include drilling cuttings and tailings (hereinafter collectively referred to as “cuttings”), brine water, and flow-back (brine water and flow-back hereinafter collectively referred to as “flow-back”). These byproducts may include any number of environmental contaminants, and therefore are desirably disposed of in a cost-efficient and environmentally-friendly manner. The present application discloses systems and methods for recycling these byproducts into concrete structures in a closed-loop system that are both economical and safe for the environment.

Drilling companies currently use liners and dirt containment berms placed around each drilling well in order to provide safeguards against environmental contamination from well flow-back. The use of existing liners and dirt containment berms has several drawbacks. First, the dirt containment berms and existing liners are prone to leaking, which would permit flow-back and/or environmental contaminants to leak into the ground near the drilling site. Second, since in many jurisdictions the byproducts are considered an environmental contaminant and therefore may not be simply worked into the dirt containment berms, drilling companies spend large amounts of money to transport these byproducts into other jurisdictions.

Further, drilling companies currently use a bed of graded stone arranged around the drilling site to a depth of between 12 inches (0.304 meters) to 48 inches (1.21 meters) to provide a base for supporting the drilling equipment. One drawback to the use of graded stone as a support base is that these stones tend to shift and re-settle over time, thereby causing the drilling equipment to shift in position. In addition, installation of the stone bed is costly and time-consuming.

Another inventive concept is to use the byproducts to construct a permanent, concrete drilling pad which surrounds a drilling site. Concrete drilling pads provide a more stable foundation than a bed of graded stone, and therefore can better hold the drilling equipment in the desired position without undesired shifting thereof. Concrete drilling pads also provide permanent, impervious environmental containment of any flow-back and/or contaminants which may leak from the drilling site, thereby eliminating the need for the use of dirt containment berms and existing liners. Moreover, as further discussed below, since the byproducts from the drilling site are incorporated into the concrete drilling pad, substantial cost savings may be realized since there is no need to transport the byproducts off of the drilling site for disposal. As discussed in further detail below, in some embodiments according to the present inventive concepts, the drilling byproducts that are collected from a first drilling site may be used to form the concrete that is to be poured into a drilling pad at a second drilling site. The drilling byproducts that are collected from the second drilling site may then be used to form the concrete that is to be poured into a drilling pad at a third drilling site, and so on.

In some jurisdictions, drilling byproducts are considered a residual waste that may not simply be spread on the surface of the earth or land-filled without pre-treatment. In a first exemplary method according to the present inventive concepts, the byproducts may first be mixed with quicklime (i.e., calcium oxide (CaO)) to form a waste slurry having a desired water saturation. In many cases, the cuttings will already be ground to a sufficient degree so that the aggregated byproducts may be used as a fine aggregate in the concrete-blending process. If the cuttings are too large, the waste slurry may optionally be ground, and then used as a fine aggregate that is mixed with cement, a coarse aggregate (e.g., stone or gravel), and water to form concrete of sufficient strength for the desired application. As discussed in further detail below, the waste slurry may be added to the concrete-mixing process as the final component of said process. Treatment of the byproducts with CaO permit them to be used as a component of concrete according to the existing regulations of some jurisdictions (e.g., the Commonwealth of Pennsylvania).

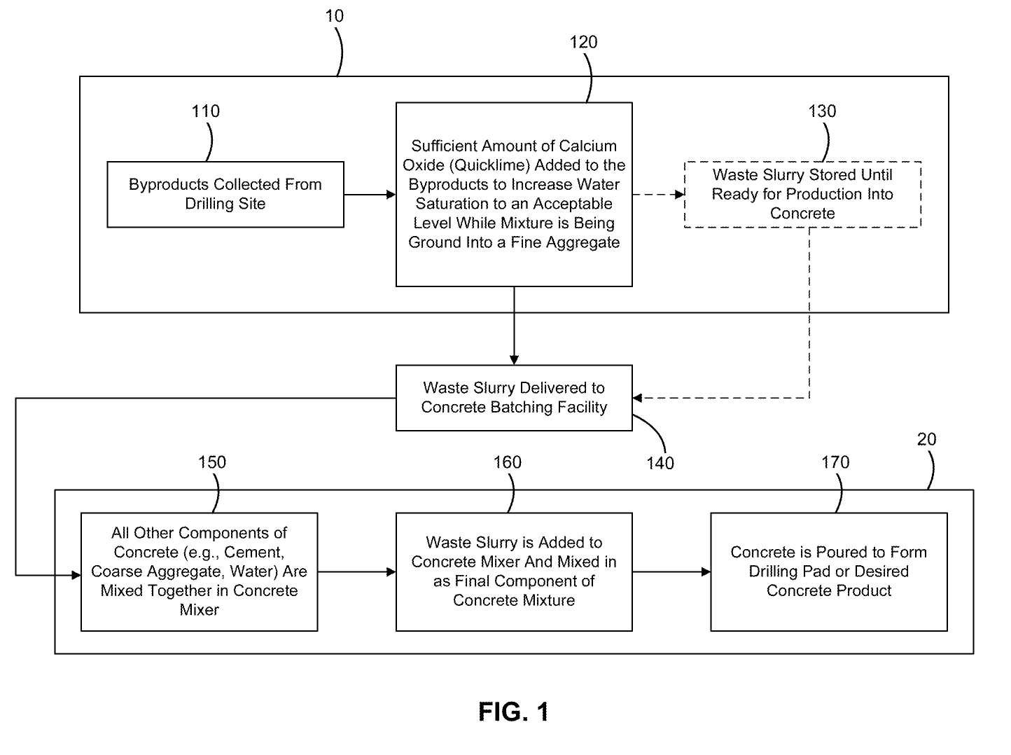

With reference to the flowchart of FIG. 1, an exemplary method for processing byproducts in order to form a concrete object will be shown. The process begins at step 110 where the byproducts are collected from a drilling site (e.g., an oil or natural gas well). The byproducts may be collected in, for example, frack, hopper trucks, or tanker trucks. At step 120, a sufficient amount of calcium oxide (commonly called “quicklime”) is added to the byproducts to decrease the water saturation to a level that is acceptable for transportation. If necessary, the waste slurry may also be ground during this initial mixing process in order to turn the waste slurry into a fine aggregate. For example, the waste slurry may be ground to a particle size that is approximately similar to the particle size of coarse sand (i.e., 0.5-1.0 mm), or may be ground to a particle size that is slightly smaller than coarse sand. Mixing of the byproducts with the CaO may occur in a pug mill, which may be set up either at the drilling site 10, as in the present exemplary method, or at a secondary site (for example, at the concrete batching facility 20 or at an intermediate site). Depending on the desired application, it may be desirable to add different amounts of CaO by mass percentage in order to achieve different saturation percentages. For example, it may be desirable to add a sufficient amount of CaO in order to achieve a saturation percentage of less than or equal to approximately 90%. It should be understood that a greater or lesser saturation percentage may be suitable within the scope of the present inventive concepts.

The specific amount of CaO that is required to achieve the desired saturation percentage in the waste slurry will vary depending on the water content of the viscous byproduct (which comprises the cuttings and flow-back). For a viscous byproduct having average water content, a general rule of thumb is to use approximately 200 pounds (90.7 kg) of CaO per one short ton (2000 lbs./907.2 kg) of byproducts. One having ordinary skill in the art will recognize that this is a general guideline only, and that a greater or lesser mass of CaO per short ton of byproducts may be necessary to achieve the desired saturation percentage. The purpose of mixing the byproducts with CaO is to reduce the water content of the waste slurry so that it can be safely transported to a concrete batching facility (e.g., concrete batching facility 20). Said another way, the desired saturation percentage must be small enough to satisfy an applicable jurisdictional regulation for the transportation of solid waste. The use of CaO as the dewatering agent is highly preferred because the CaO does not compromise the required mixing properties of the waste slurry, and also strengthens the chemical reaction of the other components of the waste slurry (e.g., limestone, shale) with the cement. In some embodiments, where the water content present in the byproducts is already at a desirable level for blending into concrete, it may be possible to omit step 120 entirely from the process.

At step 130, the waste slurry is placed in a contained, enclosed storage area until it is ready for production into concrete. The storage area should be designed to protect the processed waste material from the elements so that the saturation level of the waste material is not significantly increased or decreased during storage. For example, it may be desirable to design the storage area so that the saturation percentage of the waste material does not change more than ±10% from its starting saturation percentage (i.e., a desired saturation percentage) during storage. The storage area may comprise a concrete floor, walls, and a roof, and may be temperature-controlled to prevent the waste slurry from becoming cooled or heated much lower or higher than ambient temperature. The storage area may be sized large enough to accommodate, for example, a minimum of one week's worth of waste slurry (i.e., the volume of waste slurry generated according to the above exemplary method as a result of one week's worth of drilling) when concrete production is not ongoing. Storage of the waste slurry may occur either at the drilling site 10, as in the present exemplary method, or at a secondary site (for example, at the concrete batching facility 20 or at an intermediate site). In alternative embodiments, step 130 may be omitted from the process entirely if the generated waste slurry is to be used immediately to form concrete. At some point, the waste slurry is delivered at step 140 to a concrete batching facility 20 for production into concrete. Step 140 may occur after step 130, or, as noted above, optionally directly after step 120 where the generated waste slurry is to be used immediately to form concrete.

As shown in FIG. 1, steps 150, 160, and 170 preferably occur at the concrete batching facility 20. In this embodiment, at step 150, all of the concrete components (e.g., cement, a coarse aggregate such as stone or gravel, and water) except for the waste slurry are mixed together in a concrete mixer to form an intermediate mixture. In this embodiment, at step 160, the waste slurry is added to the intermediate mixture and is mixed in as the final component of the concrete mixture. Applicant has found that adding the waste slurry as the final component in the concrete mixing process improves the dispersion of the liquid components in the mixture and thereby reduces the tendency of the mixture to clump. Clumping of the mixture renders it more difficult to mix and reduces the elasticity thereof, and is therefore undesirable. The percentages (by weight) of each component that are added to the concrete-mixing process may be adjusted according to the desired compressive strength of the concrete that is to be produced. Several examples of different relative percentages of the components of the concrete-mixing process are provided below. Referring back to FIG. 1, at step 170, the fully-constituted concrete mixture is transferred to a pouring site and poured to form a drilling pad or some other desired concrete product.

In alternate embodiments, it may be desirable to withhold a portion of the water from the intermediate mixture so that, after the waste slurry is added to the intermediate mixture, the additional water may be added (if necessary) to form the final concrete mixture. In these embodiments, a final portion of water—and not the waste slurry—would be the final component added to the intermediate mixture. This may be necessary where, for example, there is some likelihood that the saturation percentage of the waste slurry will increase between the time that it is prepared and the time that it is mixed into the concrete. The theory behind this approach is that—in situations where the water content in the waste slurry becomes higher at the time of concrete mixing than it was at the time of waste slurry preparation—it is more desirable to have too little water in the mixture than too much. In theory, it would be much simpler to add a necessary amount of water to the concrete mixture than it would be to remove water from the concrete mixture at this point.

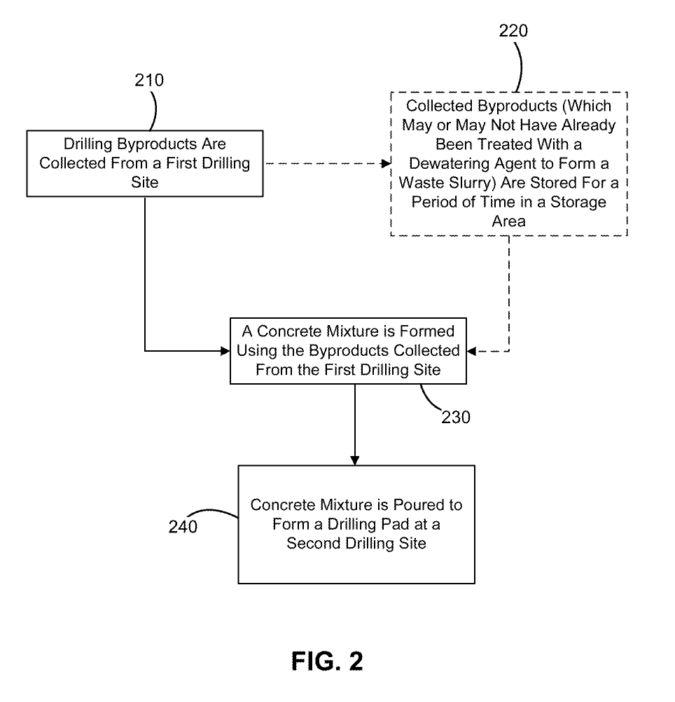

As noted above, another inventive concept taught by the present disclosure is to use drilling byproducts to construct a permanent, concrete drilling pad which surrounds a drilling site. With reference to FIG. 2, in a first exemplary method according to the present inventive concepts, at step 210 drilling byproducts are collected from a first drilling site, and then these drilling byproducts are formed at step 230 into a concrete mixture. Optionally, prior to step 230, the collected byproducts may be stored at step 220 for a period of time in a storage area prior to being formed into the concrete mixture at step 230. The concrete mixture may then be used at step 240 to form a drilling pad at a second drilling site. The systems and methods taught herein for forming the concrete that is to be used to form the drilling pad at the second drilling site are fully applicable to the exemplary method shown in FIG. 2. After step 240, well-drilling equipment may be set up at the second drilling site on the drilling pad, and drilling may then occur at the second drilling site. The drilling byproducts that are collected from the second drilling site may then be used to form the concrete that is to be poured into a drilling pad at a third drilling site, and so on. In this way, the herein disclosed systems and methods create a closed-loop system for disposal of drilling byproducts.

In some alternative embodiments, drill byproducts collected according to the present inventive concepts may be used as a component of ready-mix concrete, which may be delivered to work sites either pre-mixed, or first delivered to a site and then mixed on-site. In further alternative embodiments, drill byproducts may be used to construct pre-cast concrete structures, for example landscape pavers, cultured stone, concrete masonry units, retention wall blocks, and the like. Other suitable applications for concrete that includes recycled drill byproducts from drilled wells will be appreciated by one having ordinary skill in the art.

### EXAMPLES

The following examples provide exemplary embodiments according to the present inventive concepts, and are not intended to limit the scope of the inventive concepts in any way.

### Example 1

A concrete mixture consisting of approximately 10-20% by mass Type 1 cement, approximately 30-40% by mass coarse aggregate, approximately 35-45% by mass cuttings and flow-back (including water contained in the flow-back and any added CaO), and approximately 5-10% by mass water was found to produce concrete having a 28-day compressive strength of 2000 psi (13,790 kPa).

### Example 2

A concrete mixture consisting of approximately 15-25% by mass Type 1 cement, approximately 40-50% by mass coarse aggregate, approximately 20-30% by mass cuttings and flow-back (including water contained in the flow-back and any added CaO), and approximately 7.5-12.5% by mass water was found to produce concrete having a 28-day compressive strength of 3000 psi (20,684 kPa).

It should be understood that for concrete having a different desired compressive strength, these relative percentage ranges may be adjusted accordingly within the scope of the present inventive concepts.

While the principles of the herein disclosed inventive concepts have been described above in connection with preferred embodiments, it is to be clearly understood that this description is made only by way of example and not as a limitation of the scope of said inventive concepts.

1. A method for producing concrete from drilling byproducts, the method comprising:
mixing the drilling byproducts with a sufficient amount of a dewatering agent to form a waste slurry having a desired saturation percentage;
blending together all of the components of concrete except for the waste slurry to form an intermediate mixture; and
mixing the waste slurry into the intermediate mixture to form a concrete mixture.

2. The method of claim 1, wherein the dewatering agent is calcium oxide.

3. The method of claim 1, wherein the intermediate mixture consists essentially of cement, a coarse aggregate, and water.

4. The method of claim 1, wherein the drilling byproducts consist essentially of drilling cuttings and flow-back.

5. The method of claim 1, further comprising grinding the drilling byproducts and the dewatering agent into a fine aggregate while they are being mixed together to form the waste slurry.

6. The method of claim 1, wherein the desired saturation percentage is less than or equal to approximately 90%.

7. The method of claim 1, wherein the desired saturation percentage is small enough to satisfy an applicable jurisdictional regulation for the transportation of solid waste.

8. The method of claim 1, further comprising storing the waste slurry in a storage area before it is mixed into the intermediate mixture, wherein the storage area is designed to maintain a saturation percentage of the waste slurry to within ±10% of the desired saturation percentage.

9. The method of claim 8, wherein the step of storing the waste slurry in a storage area occurs at a same location as the step of mixing the drilling byproducts with a sufficient amount of the dewatering agent to form the waste slurry.

10. The method of claim 8, wherein the step of storing the waste slurry in a storage area occurs at a same location as the blending step.

11. The method of claim 1, further comprising pouring the concrete mixture to form a concrete structure.

12. The method of claim 11, wherein the pouring step occurs at a permanent location for the concrete structure.

13. A method for producing concrete, the method comprising:
blending together cement, a coarse aggregate, and water to form an intermediate mixture; and
mixing drilling byproducts into the intermediate mixture to form a concrete mixture.

14. The method of claim 13, further comprising grinding the drilling byproducts into a fine aggregate prior to the step of mixing the drilling byproducts into the intermediate mixture.

15. The method of claim 13, further comprising mixing the drilling byproducts with a dewatering agent to form a waste slurry prior to the step of mixing the drilling byproducts into the intermediate mixture.

16. The method of claim 14, further comprising mixing the drilling byproducts with a sufficient amount of the dewatering agent to form the waste slurry with a desired saturation percentage.

17. The method of claim 16, wherein the desired saturation percentage is less than or equal to approximately 90%.

18. The method of claim 14, wherein the dewatering agent is calcium oxide.

19. A method of using drilling byproducts to form a concrete drilling pad, the method comprising:
making a concrete mixture from drilling byproducts that are collected from a first drilling site; and
using the concrete mixture to form a concrete drilling pad at a second drilling site.

20. The method of claim 19, wherein the step of making the concrete mixture further comprises:
mixing the drilling byproducts with a dewatering agent to form a waste slurry; and
storing the waste slurry in a storage area before it is mixed into the concrete mixture.
